(19) United States
(12) Patent Application Publication
(10) Pub. No.: US 2023/0151750 A1
(43) Pub. Date: May 18, 2023

(54) ELECTRICALLY HEATED FLUID TREATMENT SYSTEM FOR LOW AND HIGH VOLTAGE APPLICATIONS

(71) Applicant: CORNING INCORPORATED, CORNING, NY (US)

(72) Inventors: Song Lyu, Painted Post, NY (US); Varvara Manuilova, St. Petersburg (RU); Min Shen, Horseheads, NY (US)

(21) Appl. No.: 17/962,850

(22) Filed: Oct. 10, 2022

Related U.S. Application Data
(60) Provisional application No. 63/280,213, filed on Nov. 17, 2021.

(51) Int. Cl. F01N 3/20; F01N 3/28

(52) U.S. Cl. CPC F01N 3/2026; F01N 3/2803

(57) ABSTRACT

A heater for treatment of a fluid flow, a method of manufacturing a heater, and method of treating an exhaust gas with a heater. The heater includes a honeycomb structure including an array of intersecting walls defining channels extending axially between a first face and a second face. The intersecting walls comprise a thermally conductive material. A resistive heating element is engaged against the first face of the honeycomb structure. The heating element comprises an electrically conductive element coated with a thermally-conductive electrical insulator. The thermally-conductive insulator electrically insulates the electrically conductive element from the honeycomb structure.

### CROSS-REFERENCE TO RELATED APPLICATION

This application claims the benefit of priority under 35 U.S.C. § 119 of U.S. Provisional Application Ser. No. 63/280,213 filed on Nov. 17, 2021, the content of which is relied upon and incorporated herein by reference in its entirety.

### FIELD OF THE DISCLOSURE

The present disclosure is directed generally to systems and methods for treating fluid streams, more particularly aftertreatment systems for treating engine exhaust, and in particular assemblies for heating a catalyst to improve catalytic performance.

### BACKGROUND

Catalytic converters or other catalyst-loaded aftertreatment components can be used to reduce toxins and pollutants in exhaust gas via chemical reactions between components of the exhaust gas with a catalyst carried by the catalytic converter. Initiation of these chemical reactions, which may be referred to as “light off,” requires sufficiently high temperatures. The heat for light off may be supplied from the heat of the exhaust being treated. As such, catalytic converter performance may be limited in the period immediately following the start of a vehicle's engine, also known as a “cold start,” during which the temperature of the catalyst is still below its light off temperature. As a result, cold start emissions can be a primary contributor for total tail pipe emission accumulation.

There is a need in the art to reduce total emissions, such as by reducing cold start time or otherwise maintaining the catalyst above its light off temperature during engine operation in both low and high voltage applications.

### SUMMARY

This disclosure generally relates to a heater, a method for manufacturing a heater, and a method for heating exhaust gas.

Generally, in one aspect, a heater is provided. The heater comprises a honeycomb structure comprising an array of intersecting walls defining channels extending axially between a first face and a second face, wherein the intersecting walls comprise a thermally conductive material; and a resistive heating element engaged against the first face of the honeycomb structure, the heating element comprising an electrically conductive element coated with a thermally-conductive electrical insulator, wherein the thermally-conductive insulator electrically insulates the electrically conductive element from the honeycomb structure.

In embodiments, the array of intersecting walls extends to an outer periphery of the honeycomb structure.

In embodiments, the walls of the honeycomb structure are made of metal.

In embodiments, the resistive heating element is arranged within a trench formed in the first face of the honeycomb structure.

In embodiments, the thermally-conductive electrical insulator comprises a ceramic.

In embodiments, the electrically conductive element comprises an iron-chromium-aluminum alloy.

In embodiments, the resistive heating element is spiral-shaped.

In embodiments, the resistive heating element is serpentine or winding-shaped.

In embodiments, the electrically conductive element is arranged in parallel with itself in a portion of the resistive heating element.

In embodiments, the electrically conductive element and thermally-conductive insulator are at least partially enclosed by an outer jacket.

In embodiments, the outer jacket is welded or brazed to the honeycomb structure.

In embodiments, the honeycomb structure is less than 1 inch in axial thickness.

In embodiments, the heater further comprises a second honeycomb structure, the second honeycomb structure comprising a first face engaged against the resistive heating element.

In embodiments, the first face of the second honeycomb structure is engaged against the first face of the honeycomb structure.

In embodiments, the resistive heating element is at least partially arranged within a trench formed in the first face of the second honeycomb structure.

In embodiments, the resistive heating element is at least partially arranged within a first trench formed in the first face of the first honeycomb structure and at least partially arranged within a second trench formed in the first face of the second honeycomb structure.

In embodiments, the honeycomb structure is cylindrical.

Generally, in one aspect, an exhaust aftertreatment system is provided. The exhaust aftertreatment system comprising the heater of any of the preceding paragraphs and an aftertreatment component downstream of the heater.

In embodiments, the aftertreatment component comprises a catalyst-carrying substrate or a particulate filter.

In embodiments, the resistive heating element is connected to a voltage source configured to supply a voltage to the resistive heating element.

In embodiments, the voltage is in a range of 12 V to 600 V.

In embodiments, the voltage is in a range of 300 V to 600V.

In embodiments, the voltage is selected to cause the resistive heating element to generate heat sufficient to increase a temperature of the walls of the honeycomb structure to at least 500 degrees Celsius.

In embodiments, the voltage is selected to cause the resistive heating element to generate heat sufficient to increase a temperature of the walls of the honeycomb structure to at least 750 degrees Celsius.

Generally, in one aspect, a method for manufacturing a heater is provided. The method comprises forming a honeycomb structure comprising an array of intersecting walls defining channels extending axially between a first face and a second face, wherein the intersecting walls comprise a thermally conductive material; and arranging a resistive heating element against the first face of the honeycomb structure, wherein the resistive heating element comprises an electrically conductive element coated with a thermally-conductive electrical insulator that electrically insulates the electrically conductive element from the honeycomb structure.

Generally, in one aspect, a method of treating exhaust gas is provided. The method comprises supplying a resistive heating element engaged against a first face of a honeycomb structure with a voltage, wherein the resistive heating element comprises an electrically conductive element coated with a thermally-conductive electrical insulator that electrically insulates the electrically conductive element from the honeycomb structure, wherein the honeycomb structure comprises an array of intersecting walls defining channels extending axially between the first face and a second face, and wherein the intersecting walls comprise a thermally conductive material; flowing a exhaust gas through the honeycomb structure; and heating a downstream aftertreatment component with the flow of exhaust gas.

Other features and advantages will be apparent from the description and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various examples.

FIG. 1 is a top view of a honeycomb structure, according to an example.

FIG. 2A is a top view of a spiral-shaped heating element arranged on a honeycomb structure, according to an example.

FIG. 2B is a cross-sectional view of a spiral-shaped heating element, according to an example.

FIG. 3A is a top view of a winding-shaped heating element arranged on a honeycomb structure, according to an example.

FIG. 3B is a cross-sectional view of a winding-shaped heating element, according to an example.

FIG. 4 is a perspective view of a spiral-shaped heating element arranged on a honeycomb structure, according to an example.

FIG. 5 is a perspective view of a spiral-shaped heating element arranged in between two honeycomb structures, according to an example.

FIG. 6 is a schematic of an exhaust system with a heater, according to an example.

FIG. 7 is an electrical schematic of an exhaust gas heating system, according to an example.

FIG. 8 is a method for manufacturing a heater, according to an example.

FIG. 9 is a method of heating exhaust gas, according to an example.

### DETAILED DESCRIPTION

This disclosure generally relates to a heater, a method for manufacturing a heater, and a method for heating exhaust gas, e.g., for use in an automobile or other engine-containing device. These devices, systems, and methods may be useful to improve catalytic converter performance through upstream heating of exhaust gas, thus hastening light off, lowering cold start time, and significantly reducing both cold start emissions and total tail pipe emissions. This upstream heating is achieved using a honeycomb structure with an array of intersecting walls. The intersecting walls form channels extending axially between a first face and a second face of the honeycomb structure, and are made of a thermally conductive material, such as a metal. The array extends to the outer periphery of the honeycomb structure for optimized heating of exhaust gas passing through the channels.

The exhaust system of an automobile may be a harsh, wet environment. Accordingly, this environment may present challenges for resistive heaters that have structures (e.g., walls) that directly participate in both the heat generation (due to flowing of current through the structures) as well as heat transfer with the fluid flow, especially at high voltages where the harsh environment may cause electrical shorts or otherwise interfere with electrical performance. As described herein, by decoupling the electrically conductive element (through which current is flowed to generate heat), from the honeycomb structure that performs heat transfer with the exhaust gas, the heaters described herein are applicable to a wide range of voltage applications, including both low and high voltages.

The honeycomb structure is heated by a heating element affixed to the first face of the honeycomb structure. The heating element can be arranged within a trench on the first face of the honeycomb structure, and can be configured in a variety of shapes, such as a spiral or a winding. The heating element includes an electrically conductive element coated with a thermally conductive electrical insulator, such as a ceramic. Thus, the heating element heated by the high voltage source is thermally coupled to the honeycomb structure, while also being electrically isolated.

This configuration of the honeycomb structure and heating element provides a number of advantages over the existing technology. First, the thermally-conductive honeycomb structure improves heating efficiency with increased surface area compared to similar heaters. Further, due to the electrically insulative structure of the heating element, the configuration is appropriate for a wide range of voltages including both low voltage (e.g., from the batteries of traditional internal combustion engine vehicles) and high voltage (e.g., from the battery systems of hybrid or electric vehicles) applications, such as broadly over a range of about 12 V to about 600 V. Third, engaging the heating element against the honeycomb array provides for a structure with improved durability and stability over similar heaters.

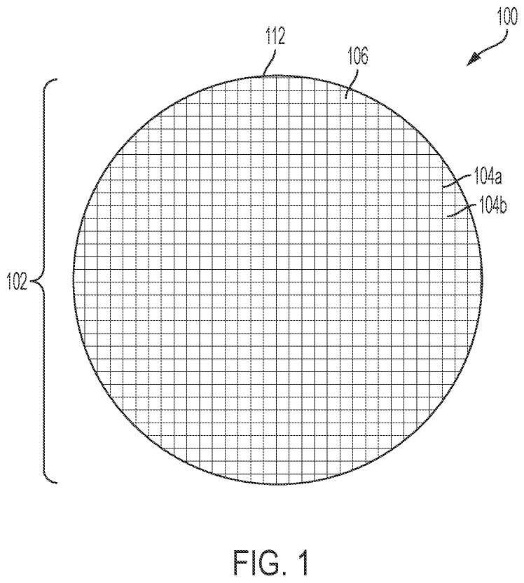

FIG. 1 shows an example honeycomb structure 100. The honeycomb structure 100 is formed by an array 102 of intersecting walls 104. For example, FIG. 1 shows how walls 104a (extending in a first direction) and walls 104b (extending in a second direction) intersect. The intersecting walls 104 form a plurality of channels 106. The walls 104 are illustrated as defining a square shape for the channels 106, although other channel shapes can be used, such as hexagonal, rectangular, triangular, or other polygons, or combinations thereof. As shown in FIG. 1, the channels can extend to the outer periphery 112 of the honeycomb structure 100. The walls 104 of the honeycomb structure 100 comprise a thermally conductive material, such as a metal or metal-like material. Accordingly, when the honeycomb structure 100 is heated as described herein, fluid (e.g., exhaust gases) flowing through the channels 106 formed by the intersecting walls 104 is heated by heat transfer with the walls 104 of the honeycomb structure 100. In one example, the axial thickness of the honeycomb structure is less than two inches, or even less than one inch. However, other axial thicknesses are possible depending on the particulars of the application, such as the dimensions of piping in. The honeycomb structure 100 can be manufactured through a variety of processes, such as extrusion or additive manufacturing.

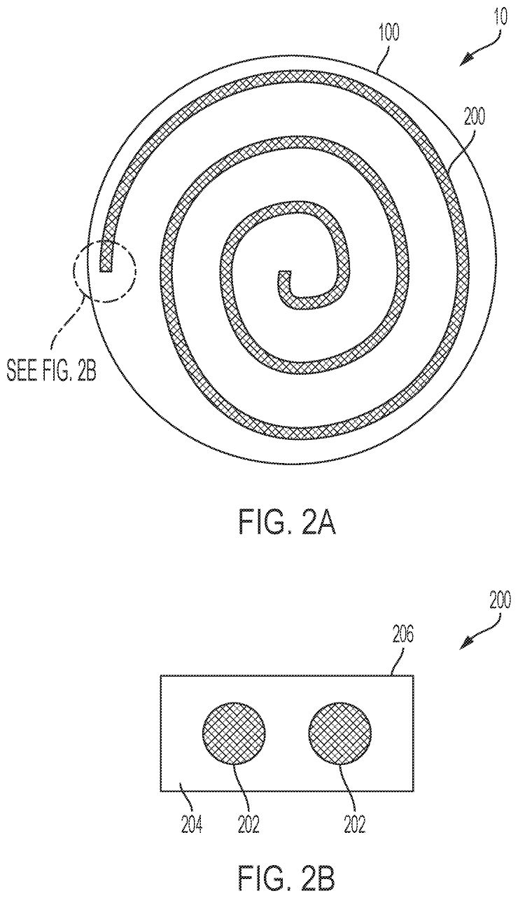

FIG. 2A shows a top view of a heater 10 comprising a heating element 200 arranged with the honeycomb structure 100 (the walls 104 of the honeycomb structure 100 not shown in FIG. 2A). FIG. 2B shows a cross-sectional view of the heating element 200. The heating element 200 is illustrated as having a spiral shape in FIGS. 2A-2B, although other shapes, such as a serpentine, zig-zag, bent, winding, circuitous, or other shape that fits within the dimensions of the outer perimeter 112 of the honeycomb structure 100. The heating element 200 engages with, or affixes to, the honeycomb structure 100 in order to transfer heat to the honeycomb structure 100. The heating element 200 is comprised of an electrically conductive element 202, such as a wire. When a voltage is applied to the terminals of the electrically conductive element 202, a current flows through the electrically conductive element 202. This current causes the electrically conductive element 202 to generate heat due to internal resistance of the electrically conductive element 202. In one example, the electrically conductive element 202 is an iron-chromium-aluminum alloy, although other electrically conductive materials can be used. This electrically conductive element 202 can have a melting point of at least 1,000 degrees Celsius, or even at least 1,300 degrees Celsius, such as approximately 1,500 degrees Celsius in the case of iron-chromium-aluminum alloys.

As shown in FIG. 2B, both terminals of the electrically conductive element 202 are accessible at the end of the heating element 200 closest to the outer periphery 112 of the honeycomb structure. This is achieved by running dual parallel segments of the electrically conductive element 202 (such as a pair of wire) throughout the spiral-shaped heating element 200. The dual parallel segments of the electrically conductive element 202 are electrically coupled at the center-most portion of the spiral-shape to form a single element 202. In this way, the electrically conductive element 202 is arranged in parallel with itself in at least a portion of the heating element 200. The electrically conductive element 202 is coated with a thermally-conductive electrical insulator 204, such as a ceramic. The thermally-conductive electrical insulator 204 can be at least partially encompassed by an outer jacket 206, such as a metal outer jacket. For example, the outer jacket 206 can be a nickel-chromium alloy. The thermally-conductive electrical insulator 204 separates the electrically conductive element 202 an amount sufficient to provide electrical isolation of the conductive element 202 from the outer jacket 206, such as by approximately a distance of at least one millimeter, at least two millimeters, or at least three millimeters.

In the example of FIGS. 2A and 2B, the outer jacket 206 surrounds almost the entire electrically conductive element 202 with the exception of an opening on the end closest to the outer periphery 112 of the honeycomb structure 100 such that the two terminals of the electrically conductive element 202 can connect to a voltage source (e.g., the battery of an automobile). The outer jacket 206 can be affixed to the honeycomb structure via welding, brazing, mechanical fastening, or another process. This arrangement allows for the resistive heat generated by the electrically conductive element 200 to transfer through the thermally-conductive electrical insulator 204 and the outer jacket 206 to heat the honeycomb structure 100. At the same time, the thermally-conductive electrical insulator 204 prevents the current flowing through the electrically conductive element 200 from coupling to the outer jacket 206 or the honeycomb structure 100. In some examples, the parameters of the heater 10, such as the applied voltage, resistivity/conductivity of the electrical conductor 202, and heat transfer coefficients between the materials enables a transfer of heat from the outer jacket 206 to the honeycomb structure 100 results in the honeycomb structure 100 heating up to at least 500 degrees Celsius, or even at least 600 degrees Celsius, such as approximately 750 degrees Celsius or more.

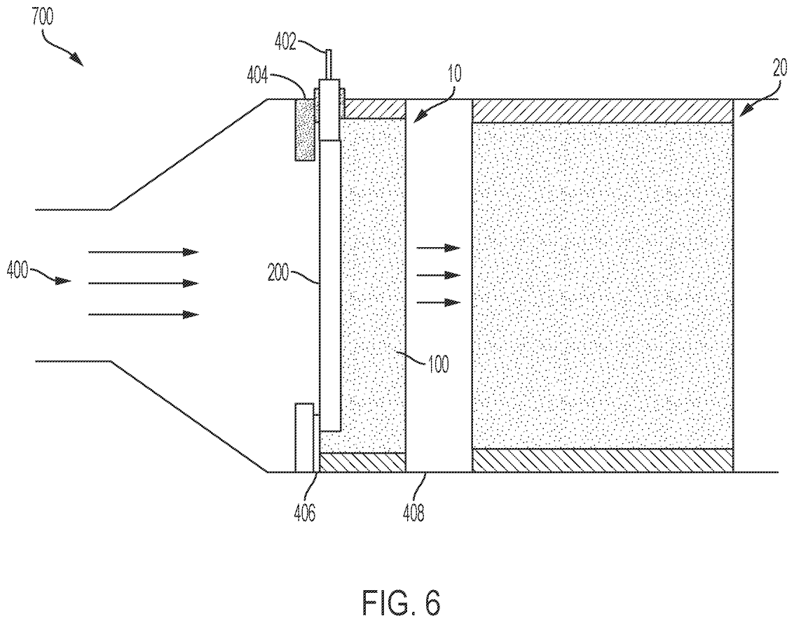

As shown in FIG. 2A, the heater 10 can be cylindrical and can be set by the outer periphery 112 of the honeycomb structure 100. However, other three-dimensional shapes are possible depending on the particulars of the application, such as a shape of piping an exhaust aftertreatment system 700 illustrated in FIG. 6 that comprises the heater 10.

The heating element 200 of FIG. 2A has three turns, although additional numbers of turns can be utilized for a spiral-shape design. However, non-spiral designs can be used, such a serpentine designs having a number of bends. In one example, the outer diameter of the shape of the heating element 200 fits within the outer periphery of the honeycomb structure 100, such as in a range of approximately three to six inches, or larger. Various other combinations of shapes, turns, bends, and/or dimensions of the heating element 200 may be used to achieve efficient heating of the honeycomb structure 100, e.g., by increasing the contact area available for heat transfer between the heating element 200 and the honeycomb structure 100.

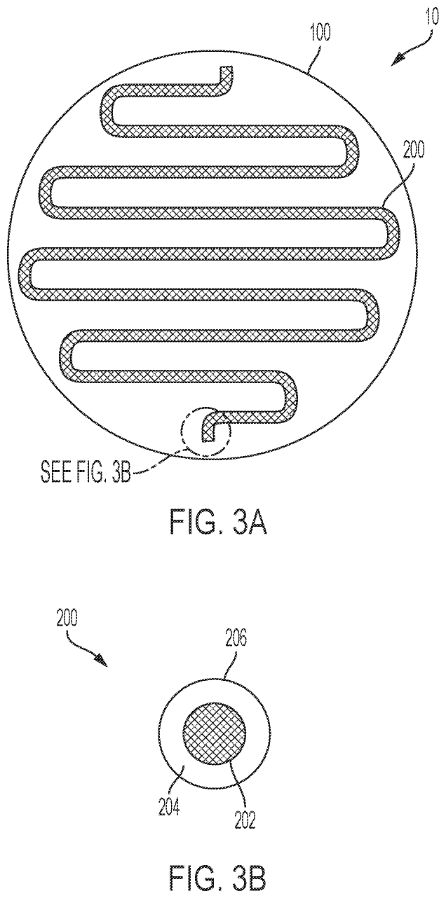

FIGS. 3A and 3B depict a variation of the heater 10 of FIGS. 2A and 2B wherein the heating element 200 is serpentine or winding-shaped. The winding-shape includes a plurality of parallel sections joined together by curved bends. Further, as shown in the cross-sectional view of FIG. 3B, each end of the heating element 200 exposes a terminal of the electrically conductive element 202. Accordingly, to heat the heating element 200, both ends of the electrically conductive element 202 must be connected to a voltage source. In further examples, the heating element 200 can be any other shape practical for distributing heat to (e.g., evenly heating) the honeycomb structure 100.

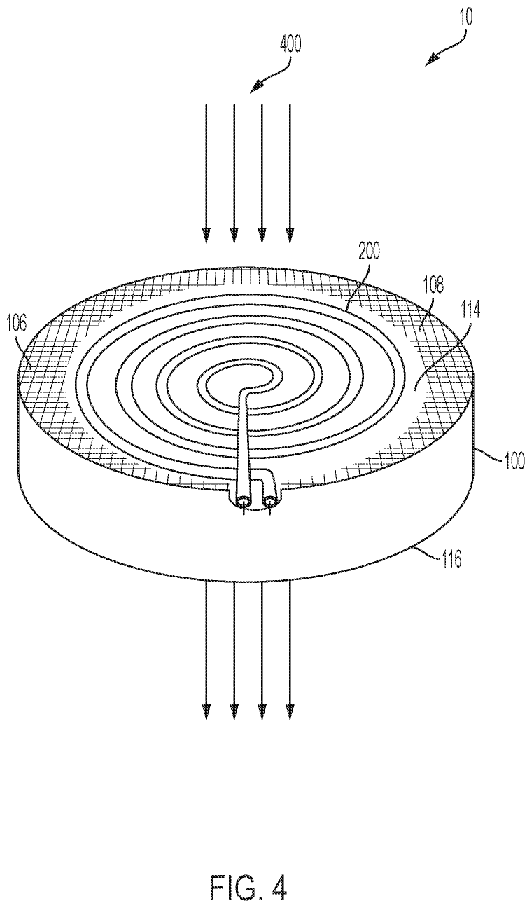

FIG. 4 depicts a perspective view of a heater 10 comprised of the heating element 200 arranged on a first face 108 of the honeycomb structure 100. The heating element 200 of FIG. 4 is capable of overlapping itself as shown in FIG. 4 without short-circuiting due to the thermally-conductive electrical insulator 204. The heating element 200 is arranged within a trench 114 formed into the first face 108 of the honeycomb structure 100. The trench 114 can have a depth approximately equal to the thickness of the heating element 200. For example, the trench 114 can be formed by removing material from the honeycomb structure 100, such as a milling, cutting, electrical discharge machining, or other process.

As previously described, the heating element 200 heats the honeycomb structure 100 when a voltage is applied to the heating element 200. Thus, the heater 10 can operate by heating a fluid flow 400 (e.g., a flow of exhaust gases or other fluid to be treated) passing through the channels 106 of the honeycomb structure 100. In one example, the fluid flow 400 can be exhaust gas generated by the engine of an automobile. The heated exhaust gas is then provided to a downstream exhaust aftertreatment component such as a catalytic converter or particulate filter, resulting in improved emission performance.

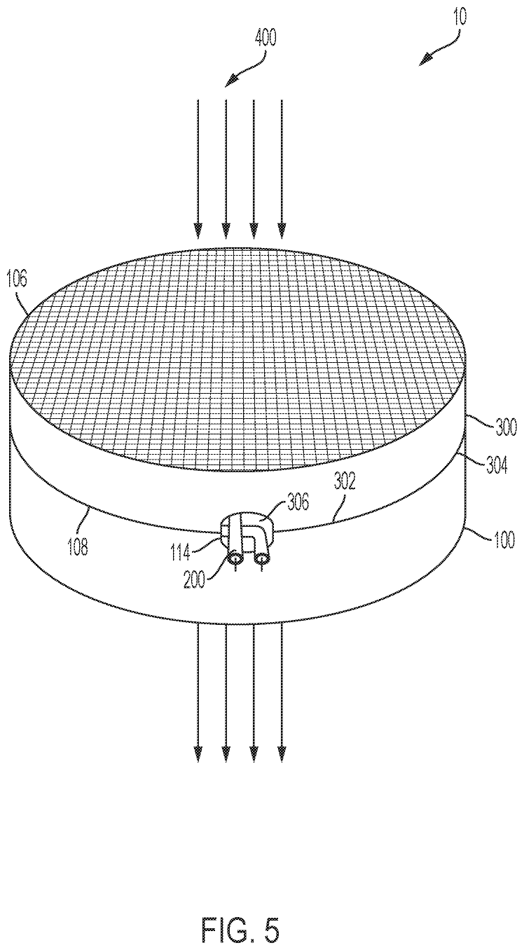

FIG. 5 depicts a perspective view of heater 100 comprised of the heating element 200 arranged in between the honeycomb structure 100 as a first honeycomb structure and a second honeycomb structure 300. The second honeycomb structure 300 can be arranged as shown in the drawings and described herein with respect to the first honeycomb structure 100, e.g., comprising the array of intersecting walls 104 that define channels 106 therethrough. In the example of FIG. 5, a first face 302 of the second honeycomb structure 300 is affixed to the first face 108 of the first honeycomb structure 100. The first and second honeycomb structures 100, 300 can be thermally coupled at an interface 304. For example, the interface 304 can comprise a thermal paste, an adhesive, brazing, welding, or other material if desired. Alternatively, the first honeycomb structure 100 and second honeycomb structure 300 can be held together by clips, bolts, clamps, or other mechanical fasteners. In embodiments, each of the honeycomb structure 100, 300 are less than 1 inch in axial thickness, or even less than 0.5 inches in axial thickness, such as approximately 0.25 inches in axial thickness or between 0.1 inches and 0.5 inches.

In order to arrange the heating element 200 between the first and second honeycomb structures 100, 300 a first trench 114 can be milled into the first face 108 of the first honeycomb structure 100, and/or a second trench 306 can be milled in the first face 302 of the second honeycomb structure 300. As such, the heating element 200 shown in FIG. 5 is arranged within the one or more trenches 114, 306. For example, the sum of the depths of the trenches 114, 306 can be substantially equal to the thickness of the heating element 200. In this way, even if one of the trenches is not included (thus, effectively has a depth of zero), the depth of the single trench would be substantially equal to the thickness of the heating element 200. In embodiments, the depth of the first trench 114 and the depth of the second trench 306 are both substantially equal to half of the thickness of the heating element 200. In an alternate example, the depth of the first trench 114 is approximately 75% of the thickness of the heating element 200, while the depth of the second trench 306 is approximately 25% of the thickness of the heating element 200. Other ratios of trench depths are possible. The dual honeycomb structure 100, 300 arrangement of FIG. 5 can produce improved heating of fluid flow 400 by utilizing conduction heat from opposite (e.g., both the top and bottom) sides of the heating element 200. Similar to the interface 304, heat transfer between the heating element 200 and the honeycomb structure 100 can be increased by addition of a thermal paste, adhesive, welding, brazing, or even mechanical fasteners that improve the thermal communication between the materials of these components.

In other examples, neither the honeycomb structures 100, 300 include a trench 114, 306 in which the heating element 200 is received. In this embodiment, the first face 108 of the first honeycomb structure 100 is only connected to the first face 302 of the second honeycomb structure 300 via the heating element 200 (and thus there is no interface 304 between the honeycomb structures 100, 300). This arrangement results in a physical gap between the first honeycomb structure 100 and the second honeycomb structure 300, which may lead to mixing of the heated fluid flow 400 with additional external, non-heated air or other gases that is pulled into the gap.

FIG. 6 is a schematic of an exhaust aftertreatment system 700 with the heater 10 (comprising only the honeycomb structure 100 but not the honeycomb structure 300, although the heater 10 can comprise both of the honeycomb structures 100, 300). The fluid flow 400, such as exhaust gas generated by the engine of the automobile, flows through the honeycomb structure 100, which is heated by the heating element 200 as described herein. After the fluid flow 400 is heated by the heater 10, the heated fluid flow can be directed to an exhaust aftertreatment component 20, such as a catalytic converter (or other catalyst-carrying substrate) or particulate filter. The heating element 200 connects to the automobile electrical system 800 via one or more electrodes 402. The heater 10 can be secured in place via retention ring 404, matting material 406, and/or other suitable components. For example, matting material 406 can be included to act as a cushion between the retention ring 404 and the heater 10 in the axial direction. Additional matting material 408 can be used about the outer periphery of the honeycomb structure 100 to prevent movement of the heater 10, e.g., due to vibrations during use. The fluid flow 400 exiting the heater 10 then travels to a downstream aftertreatment component, e.g., a catalytic converter or particulate filter, of the automobile.

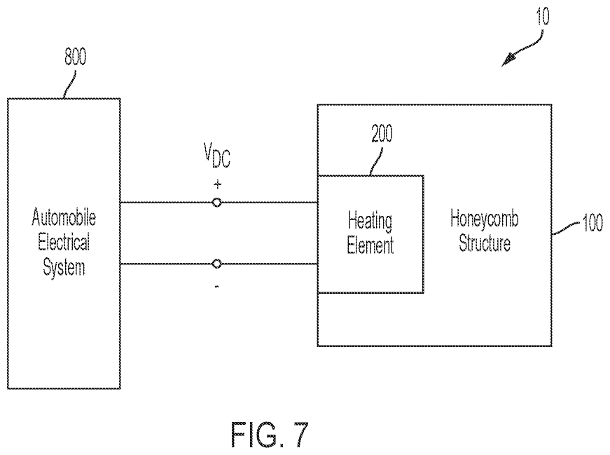

FIG. 7 is an electrical schematic of the exhaust aftertreatment system 700, according to an example. As shown in FIG. 7, the automobile electrical system 800 provides heating element 200 with a voltage, V_{DC}. The heating element 200 uses the V_{DC} to generate resistive heat, which is transferred to the thermally-conductive honeycomb structure 100. V_{DC} can be a relatively high voltage value, such as between 300 V and 600 V. This high voltage value can be due to the automotive electrical system 800 providing electrical power to an electrically powered vehicle or an automobile with a hybrid powertrain. In other examples, V_{DC} can be a relatively low voltage value, such as between 12 V and 48 V. In a further example, V_{DC} can be any voltage value between 12 V and 600 V. Accordingly, the heater 10 is a flexible device capable of being used in both low voltage and high voltage applications.

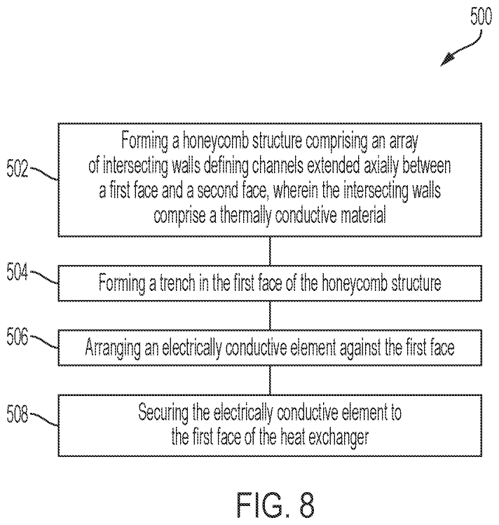

Generally, in another aspect and with reference to FIG. 8, a method 500 for manufacturing a heater is provided. The method 500 comprises forming 502 a honeycomb structure comprising an array of intersecting walls forming channels extending axially between a first face and a second face, wherein the intersecting walls comprise a thermally conductive material. In embodiments, the forming 502 is performed by extrusion or additive manufacturing.

The method 500 optionally further comprises forming 504 a trench on the first face of the honeycomb structure. In embodiments, the trench is formed in step 504 simultaneously with the honeycomb structure, e.g., via an additive manufacturing process. In embodiments, the trench is formed in step 504 by removing material from the honeycomb structure formed in step 502. In embodiments, the method 500 does not comprise forming a trench. The resistive heating element may comprise an electrically conductive element coated with a thermally-conductive electrical insulator. The electrically conductive element and thermally-conductive electrical insulator may be at least partially enclosed or encased in an outer jacket. The method 500 further comprises arranging 506 a resistive heating element against the first face of the honeycomb structure. In embodiments, arranging 506 comprises positioning the heating element within the trench if the method 500 comprises the step 504. The method 500 optionally further comprises securing 508 the heating element to the honeycomb structure. In embodiments, the securing 508 comprises welding, adhering, brazing, or mechanically connecting the heating element to the first face of the honeycomb structure.

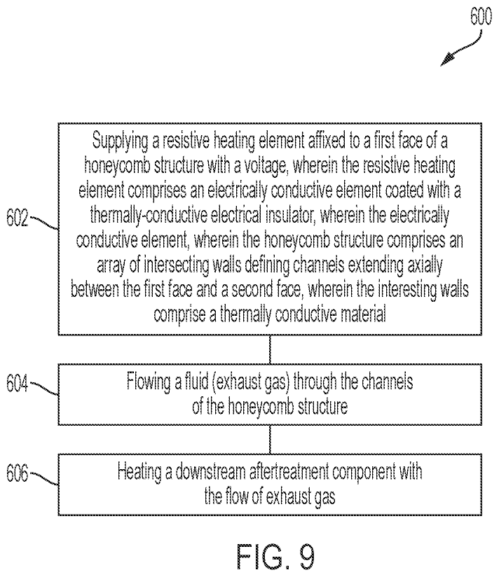

Generally, in another aspect, and with reference to FIG. 9, a method 600 of heating exhaust gas is disclosed. The method 600 comprises supplying 602 a resistive heating element engaged against a first face of a honeycomb structure with a voltage. The, In embodiments, the resistive heating element comprises an electrically conductive element coated with a thermally-conductive electrical insulator. In embodiments, the electrically conductive element and the thermally-conductive insulator are at least partially encompassed within an outer jacket. In embodiments, the honeycomb structure comprises an array of intersecting walls defining channels extending axially between the first face and a second face. In embodiments, the intersecting walls comprise a thermally conductive material.

The method 600 further comprises flow 604 a fluid, e.g., exhaust gas, through the honeycomb structure, thereby heating the exhaust gas by heat transfer with the walls of the honeycomb structure. The method 600 further comprises heating 606a downstream exhaust aftertreatment component with the flow of exhaust gas after the exhaust gas has been heated, thereby providing the downstream exhaust aftertreatment component, such as a catalyst-carrying substrate or particulate filter, with supplemental heat. In embodiments, the supplemental heat provided by the heater to the exhaust flow, and by the exhaust flow to the aftertreatment component is sufficient to initiate light off of a catalyst material carried by the aftertreatment component.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software or a combination thereof. When any aspect is implemented at least in part in software, the software code can be executed on any suitable processor or collection of processors, whether provided in a single device or computer or distributed among multiple devices/computers.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A heater for treatment of a fluid flow, comprising:
a honeycomb structure comprising an array of intersecting walls defining channels extending axially between a first face and a second face, wherein the intersecting walls comprise a thermally conductive material; and
a resistive heating element engaged against the first face of the honeycomb structure, the heating element comprising an electrically conductive element coated with a thermally-conductive electrical insulator, wherein the thermally-conductive insulator electrically insulates the electrically conductive element from the honeycomb structure.

2. The heater of claim 1, wherein the array of intersecting walls extends to an outer periphery of the honeycomb structure.

3. The heater of claim 1, wherein the resistive heating element is arranged within a trench formed in the first face of the honeycomb structure.

4. The heater of claim 1, wherein the thermally-conductive electrical insulator comprises a ceramic.

5. The heater of claim 1, wherein the resistive heating element is spiral-shaped.

6. The heater of claim 1, wherein the resistive heating element is serpentine or winding-shaped.

7. The heater of claim 1, wherein the electrically conductive element is arranged in parallel with itself in a portion of the resistive heating element.

8. The heater of claim 1, wherein the electrically conductive element and thermally-conductive insulator are at least partially enclosed by an outer jacket.

9. The heater of claim 8, wherein the outer jacket is welded or brazed to the honeycomb structure.

10. The heater of claim 1, wherein the honeycomb structure is less than 1 inch in axial thickness.

11. The heater of claim 1, further comprising a second honeycomb structure, the second honeycomb structure comprising a first face engaged against the resistive heating element.

12. The heater of claim 11, wherein the first face of the second honeycomb structure is engaged against the first face of the honeycomb structure.

13. The heater of claim 11, wherein the resistive heating element is at least partially arranged within a trench formed in the first face of the second honeycomb structure.

14. The heater of claim 12, wherein the resistive heating element is at least partially arranged within a first trench formed in the first face of the first honeycomb structure and at least partially arranged within a second trench formed in the first face of the second honeycomb structure.

15. An exhaust aftertreatment system comprising the heater of claim 1 and an aftertreatment component downstream of the heater.

16. The exhaust aftertreatment system of claim 15, wherein the aftertreatment component comprises a catalyst-carrying substrate or a particulate filter.

17. The exhaust aftertreatment system of claim 15, wherein the resistive heating element is connected to a voltage source configured to supply a voltage to the resistive heating element.

18. The exhaust aftertreatment system of claim 17, wherein the voltage is selected to cause the resistive heating element to generate heat sufficient to increase a temperature of the walls of the honeycomb structure to at least 750 degrees Celsius.

19. A method for manufacturing a heater, comprising:
forming a honeycomb structure comprising an array of intersecting walls defining channels extending axially between a first face and a second face, wherein the intersecting walls comprise a thermally conductive material; and
arranging a resistive heating element against the first face of the honeycomb structure, wherein the resistive heating element comprises an electrically conductive element coated with a thermally-conductive electrical insulator that electrically insulates the electrically conductive element from the honeycomb structure.

20. A method of treating exhaust gas, comprising:
supplying a resistive heating element engaged against a first face of a honeycomb structure with a voltage, wherein the resistive heating element comprises an electrically conductive element coated with a thermally-conductive electrical insulator that electrically insulates the electrically conductive element from the honeycomb structure, wherein the honeycomb structure comprises an array of intersecting walls defining channels extending axially between the first face and a second face, and wherein the intersecting walls comprise a thermally conductive material;
flowing a exhaust gas through the honeycomb structure; and
heating a downstream aftertreatment component with the flow of exhaust gas.
